(19) United States
(12) Patent Application Publication
(10) Pub. No.: US 2009/0267527 A1
(43) Pub. Date: Oct. 29, 2009

(54) System For Supplying In-Series Connected Light Sources

(75) Inventor: Gianni Facchini, San Carlo (Ferrara) (IT)

Correspondence Address: WILLIAM J. SAPONE;COLEMAN SUDOL SAPONE P.C., 714 COLORADO AVENUE, BRIDGE PORT, CT, 06605, US

(73) Assignee: O.C.E.M. S.p.A., S. Giorgio di Piano (Bologna) (IT)

(21) Appl. No.: 12/439,182

(22) PCT Filed: Aug. 28, 2007
(86) PCT No.: PCT/EP07/58934

§ 371 Date: Feb. 27, 2009

(30) Foreign Application Priority Data
Aug. 31, 2006 (IT) BO2006A 000622

(51) Int. Cl. H05B 39/00

(52) U.S. Cl. 315/185 R

(57) ABSTRACT

A supply system for light sources connected in series is powered by one power line (SE), and a plurality of adjustment units (UR₁, UR₂, . . . , UR_{J}, . . . UR_{N}) are interposed between the power line (SE) and an electric circuit (E) for in-series connection of light sources (SI₁, SI₂, . . . , SI_{J}, . . . SI_{N}). Each of the adjustment units (UR_{J}) has a (DC/AC_{J}) generator device for the generation of an alternating voltage. An electric transformer (T_{J}) is connected in cascade and functionally with the electric circuit (E). An electric central unit (C), connected to the generator devices, controls modulation of the alternating voltage supplied by the generator device, so as to obtain a current (z) circulating in the electric circuit (E), having pre-defined electric characteristics.

### FIELD OF THE INVENTION

The present invention relates to systems for supplying in-series connected light sources, e.g. aimed at serving the airport runways.

### BACKGROUND OF THE INVENTION

Supply systems as mentioned above are usually situated in one or more units of an airport and each of them usually includes (see FIG. 1): constant-current adjustment unit URN, connected for example to a three-phase power line SE, aimed at powering an electric circuit E, in which a plurality of light sources SI₁, SI₂, . . . , SI_{N} are arranged in series; an electric central unit CE, which receives an input of an external signal EXT, transmitted for example by the control tower, and a feedback control signal RET, supplied by a sensor S (such as a current transformer TA), representing the current z circulating in the electric circuit E, and which is aimed at controlling the operation of the adjustment unit URN by a corresponding signal KK.

Each light source SI_{J} includes a corresponding auxiliary device D_{J} of known type, which supplies a relevant lamp L_{J}, for example a ground-half-dipped light signaling unit (known to those skilled in the field also as “light signal”).

The constant-current adjustment unit URN includes: a conversion apparatus ACN, consisting in turn of an AC/DC rectifier, connected to the three-phase (or mono-phase) power line SE, for converting the alternate three-phase voltage in a direct voltage, a DC-to-AC inverter connected in cascade with the AC/DC rectifier, aimed at transforming the direct voltage again in an alternating voltage waveform, whose characteristics (frequency and/or amplitude and/or effective value) can be pre-defined by the control signal KK; and an electric transformer TN, whose primary winding is connected to the output terminals of the DC-to-AC inverter and the secondary winding is connected to the electric circuit E.

The electric central unit CE is aimed at operating the modulation of the voltage supplied by the DC-to-AC inverter, for example in terms of variation of its effective value, depending on the result of a comparison between the external signal EXT and the feedback control signal RET: in particular, the external signal EXT contains information about the lighting level required in the runway, therefore, in other words, it is in charge of controlling and adjusting the current z circulating in the electric circuit E, which is followed by corresponding current values (not indicated) of powering of the lamps L₁, L₂, . . . , L_{J}, . . . , L_{N}, supplied by the auxiliary devices D₁, D₂, D_{J}, . . . , D_{N}.

The just described power system must operate with high reliability performances, to ensure the continuous and regular powering of the light sources SI₁, SI₂, . . . , SI_{N}, for obvious safety reasons; consequently, certain solution (indeed, few) include a redundant adjustment unit (not shown), disposed in parallel to the unit URN and aimed at coming into operation in case of failure or maintenance of the latter. This solution ensures, obviously, regular operating of the supplying system, but leads to a considerable costs increase.

Moreover, the design of the system for supplying a plurality of light sources SI₁, SI₂, . . . , SI_{N} can usually take into account possible insertion of supplementary electric loads in the medium to long term (just think about the runway extension, for example), therefore it is usual to expect an excess of 10-15% of the initially requested power. This represents a further increase of initial installation costs, which, besides, may not be followed by actual system expansion and consequently by its exploitation to the values of nominal power; on the other hand, a considerable amplification of the lighting system could anyway require the substitution of the whole supplying system with one of suitable nominal power.

### SUMMARY OF THE INVENTION

In the light of the above statements, the object of the present invention is to propose a newly conceived system for supplying a plurality of light sources in series, situated in one or more distinct adjusting units, of limited nominal power, so as to resolve satisfactorily the above mentioned drawbacks peculiar to the prior art; it is meant to propose with that a system that ensures high reliability operation and whose costs are all in all lower with respect to the known solutions.

The above mentioned objects are obtained, in accordance with the contents of the claims, by a system for supplying light sources connected in series by an electric circuit, the system being powered by at least one power line and characterized in that it includes:

a plurality of adjustment units, functionally interposed between said power line and the electric circuit for in-series connection of said light sources;

a generator device for each said adjustment unit, the generator being powered by said power line, for the generation of alternating voltage having pre-definable characteristics;

an electric transformer for each said adjustment unit, the electric transformer being connected in cascade with the generator device and connected functionally with said electric circuit, for in-series connection of said light sources; and

an electric central unit, connected, at least at one end, to said generator devices, to control modulation of the alternating voltage supplied by the same generator device, so as to obtain a current circulating in the electric circuit for in-series connection of said light sources having pre-definable electric characteristics.

### BRIEF DESCRIPTION OF THE DRAWINGS

The characteristic features of the invention, not appearing from what has just been said, will be better pointed out in the following, in accordance to what is reported in the claims and with help of the enclosed drawings, in which:

FIG. 1 shows a partial block electric diagram of a system of known type, which supplies a plurality of light sources connected in series;

FIG. 2 shows an block electric diagram of a supplying system proposed by the present invention, which supplies a plurality of light sources connected in series;

FIG. 3 shows an enlarged detail of the previous Figure.

### BEST MODES OF CARRYING OUT THE INVENTION

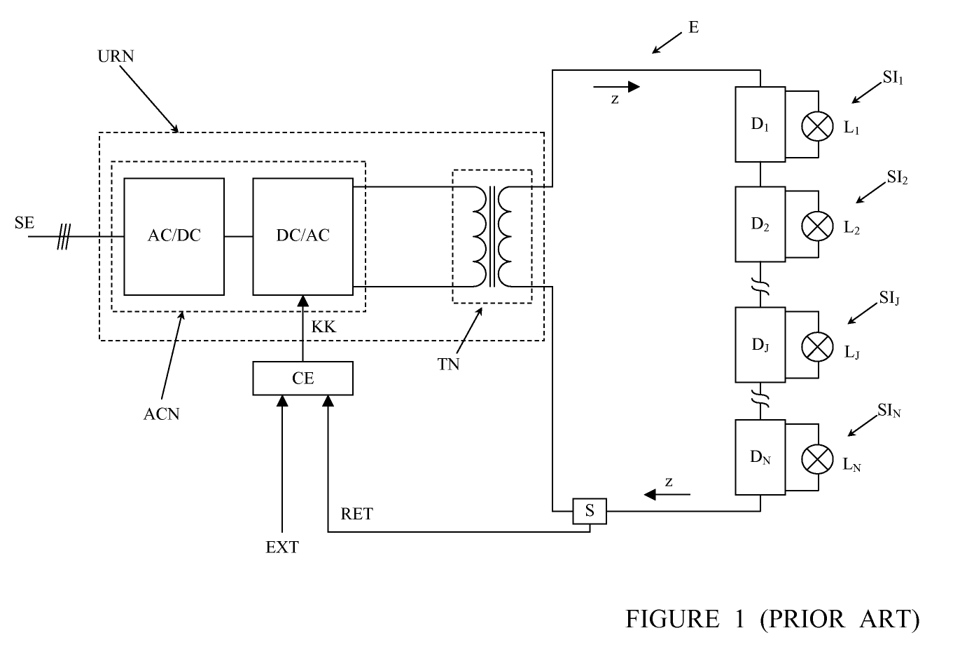

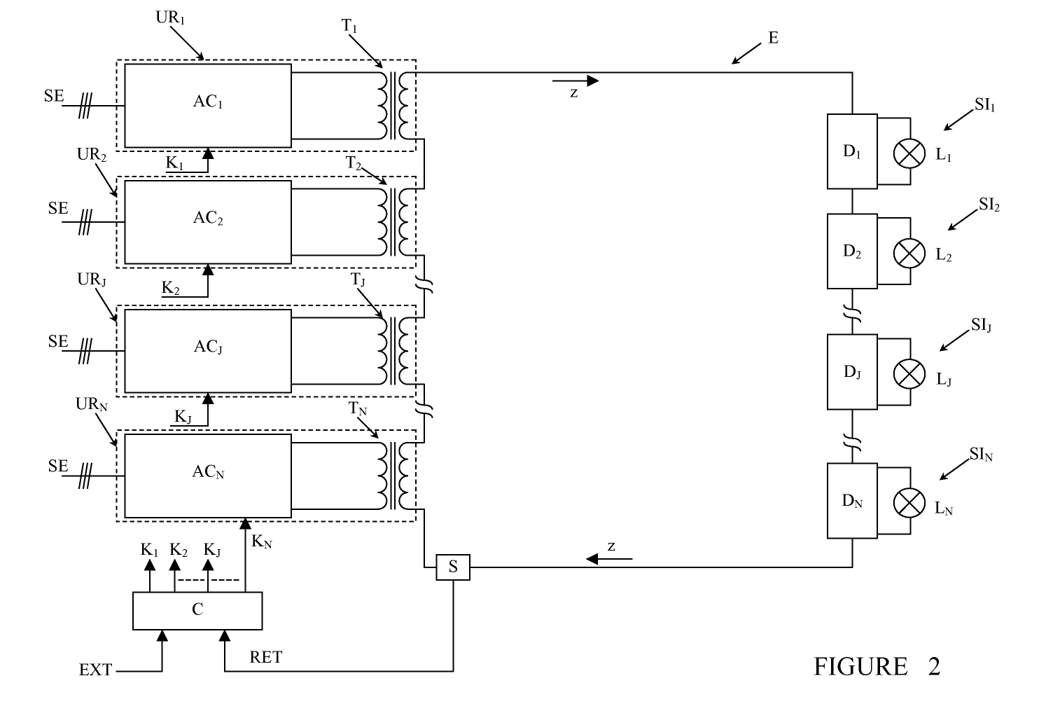

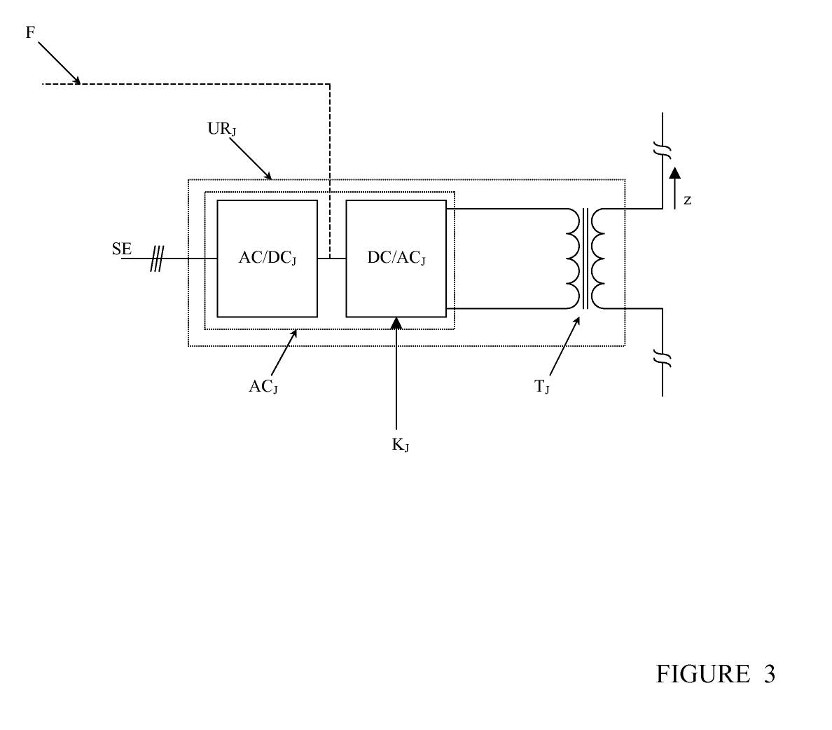

With reference to FIGS. 2, 3, some numerical references, already defined in FIG. 1 (prior art), will be maintained in the following description, as relevant to elements, electric signals or electric quantities, which are common from the functional point of view.

The system proposed by the invention (FIG. 2) includes a plurality of adjustment units UR₁, UR₂, . . . , UR_{J}, . . . , UR_{N}, functionally interposed between, for example, a three-phase or mono-phase power line SE, and the electric circuit E, of series connection of the plurality of light sources SI₁, SI₂, . . . , SI_{N}; each generic adjustment unit UR_{J} includes, see FIG. 3:

an AC/DC_{J} rectifier, of known type, supplied by the power line SE, and aimed at converting the alternating voltage waveform in a direct voltage waveform;

a DC-to-AC_{J} inverter, likewise of substantially known type, powered by the same AC/DC_{J} rectifier, aimed at transforming the direct voltage, applied to its input terminals, in a form of alternating voltage wave, whose electric characteristics can be pre-defined by a corresponding control signal K_{J}, discussed later on;

and an electric transformer T_{J}, whose primary winding is connected to the output terminals of the DC-to-AC_{J} inverter and the secondary winding is connected in series along the electric circuit E. The assembly defined by the AC/DC_{J} rectifier and the DC-to-AC_{J} inverter forms the conversion apparatus AC_{J}.

The proposed supplying system includes also a central unit C, which receives the input of the external signal EXT, containing, as already said, information related to the lighting level required on the runway, and a feedback control signal RET, supplied by the a current transformer S, representing, except for a scale factor, the current z circulating in the electric circuit E; the same central unit C supplies, in output, N control signals K₁, K₂, . . . , K_{J}, . . . , K_{N}, aimed at being sent to the respective adjustment units UR₁, UR₂, . . . , UR_{J}, . . . , UR_{N}, to control, in particular, the modulation of the alternating voltage generated by the corresponding DC-to-AC inverters, so as to obtain a current z circulating in the electric circuit E, having pre-defined characteristics, depending, in any case, on the external signal EXT.

At present, in this technical field, the modulation of the voltage supplied by each DC-to-AC_{J} inverter concerns the width or effective value of the same voltage, however it is not excluded to modulate also (or only) frequency values, if necessary; in the last case, the auxiliary devices D₁, D₂, . . . , D_{J}, . . . , D_{N} will supply the corresponding lamps L₁, L₂, . . . , L_{J}, . . . , L_{N} according to current values being function of the frequency values of the current z circulating in the electric circuit E.

The adjustment units UR₁, UR₂, . . . , UR_{J}, . . . , UR_{N} are of modular type and each unit UR_{J} is designed for a substantially limited nominal power, for example 1 KVA; the functional introduction of the units UR₁, UR₂, . . . , UR_{J}, . . . UR_{N} between the three-phase power line SE and the electric circuit L is calculated to satisfy the nominal load (apparent power required by the light sources SI₁, SI₂, . . . , SI_{J}, . . . , SI_{N}) and to have for example one or more redundancy units. The presence of more adjustment units UR₁, UR₂ . . . , UR_{J}, . . . UR_{N} allows high flexibility of the system operation, depending on the needs and/or required specifications; as a not limiting example, the electric central unit C, on the basis of the external signal EXT and the feedback control signal RET, can adjust the operation of the adjustment units UR₁, UR₂, . . . , UR_{J}, . . . , UR_{N}, maintaining inactive the units UR_{N-1}, UR_{N} (which therefore act as redundancy units) and controlling the operation of the remaining units according to the same operation mode, so that the alternating voltage supplied by the secondary winding of the corresponding transformers T₁, T₂, . . . , T_{J}, . . . , T_{N-2} is the same.

Otherwise, it is also possible to alternate periodically the adjustment units aimed at remaining inactive, so as to uniform the usage time and the electric and thermal stress of each unit UR_{J}. It is also possible, still as example, to handle the supplying system operation in order to maximize its performance, adjusting accordingly the operation of the adjustment units UR₁, UR₂, . . . , UR_{J}, . . . , UR_{N}.

The present invention appears, from what above, considerably advantageous from the technical-functional point of view, being characterized not only by an operation, which is very flexible and can be set by the electric central unit C, but also by high reliability performance, due to the possibility of having one or more redundant adjustment units, that have a relatively low cost, because of their limited nominal power.

As already specified, the adjustment units are of modular type and have a relatively limited nominal power, therefore their introduction or removal, for example due to a fault of one or more pre-existing units or due to the increase of the required load power (e.g. increase of the number of light sources), is simple and rapid; the possible increase of the required load power passes simply through the introduction of a suitable number of supplementary adjustment units, and it is not necessary to dismantle the pre-existing system and to design and install a system all over again. In this sense, it becomes advisable to provide a supplying system having nominal power equal to or little higher than the required one, since its possible extension would require the simple introduction of one or more supplementary adjustment units.

Therefore, the implementation costs of the supplying system according to the present invention depend strictly on the required load power, since no excess needs to be taken into consideration; in case of the system expansion and consequently, of the required power increase, it will be enough to increase the number of the adjustment units by a suitable quantity.

Therefore, it is possible with the present invention, unlike with the prior art, to rationalize and considerably reduce the initial installation costs of the supplying system and the possible costs of its expansion, without the possibility of wastes.

It is possible, alternatively to the embodiment described above, to provide only one transformer (not shown) instead of N transformers, which has as many primary windings connected to the output terminals of the respective inverters and only one secondary winding connected in series along the electric circuit E.

Moreover, the proposed supplying system can be powered by a direct voltage instead of the three-phase power line SE, therefore in this case the adjustment units UR₁, UR₂, . . . , UR_{J}, . . . , UR_{N} would not have the corresponding AC/DC rectifiers (see broken line F in FIG. 3); otherwise, it is possible to interpose only one AC/DC rectifier between the three-phase power line and the adjustment units UR₁, UR₂, . . . , UR_{J}, . . . , UR_{N}, obviously without any rectifier inside the latter.

Finally, a supplying system without the feedback control electric signal RET, supplied by the current transformer S is intended to be within the present invention; in this case, the system will work in “open loop” mode.

It is understood that what above has been described as a not limiting example, therefore possible practical-application variants remain within the protective scope of the invention as described above and claimed below.

1. A system for supplying light sources connected in series by an electric circuit (E), the system being powered by at least one power line (SE) and characterized in that it includes:
a plurality of adjustment units (UR₁, UR₂, . . . , UR_{J}, . . . , UR_{N}), functionally interposed between said power line (SE) and the electric circuit (E) for in-series connection of said light sources (SI₁, SI₂, . . . , SI_{J}, . . . SI_{N});
a generator device (DC/AC_{J}) for each said adjustment unit (UR_{J}), the generator device being powered by said power line (SE), for the generation of alternating voltage having pre-definable characteristics;
an electric transformer (T_{J}) for each said adjustment unit (UR_{J}), the electric transformer being connected in cascade with the generator device (DC/AC_{J}) and connected functionally with said electric circuit (E), for in-series connection of said light sources (SI₁, SI₂, . . . , SI_{J}, . . . SI_{N}); and
an electric central unit (C), connected, at least at one end, to said generator devices, to control modulation of the alternating voltage supplied by the same generator device, so as to obtain a current (z) circulating in the electric circuit (E) for in-series connection of said light sources (SI₁, SI₂, . . . , SI_{J}, . . . SI_{N}), having pre-definable electric characteristics.

2. A system, according to claim 1, wherein said electric central unit (C) is also: connected to a sensor (S), for detecting a current (z) circulating in said electric circuit (E) for in-series connection of said light sources (SI₁, SI₂, . . . , SI_{J}, . . . SI_{N}).

3. A system, according to claim 1, wherein said electric central unit (C) is also: connected to a sensor (S) for detecting a current (z) circulating in said electric circuit (E) for in-series connection of said light sources (SI₁, SI₂, . . . , SI_{J}, . . . , SI_{N}); and designed to receive at least an external signal (EXT), containing information about a light radiation intensity to be emitted by said light sources (SI₁, SI₂, . . . , SI_{J}, . . . SI_{N}).

4. A system, according to claim 1, wherein each said electric transformer element (T_{J}), situated in cascade with a corresponding said generator device (DC/AC_{J}), has a secondary winding connected in series along said electric circuit (E) for series connection of said light sources (SI₁, SI₂, . . . , SI_{J}, . . . SI_{N}).

5. A system, according to claim 1, wherein said power line (SE) supplies a direct voltage and each said generator device (DC/AC_{J}), belonging to a corresponding adjustment unit (UR_{J}), is constituted by a (DC/AC) inverter device for transforming the direct voltage, supplied by said power line (SE), into alternating voltage of pre-definable characteristics, supplied to the respective electric transformer (T_{J}).

6. A system, according to claim 1, wherein said power line (SE) supplies a direct voltage, said system including, at least one (AC/DC) rectifier, which is interposed between said power line (SE) and one or more of said generator devices of alternating voltage, for converting an alternate current supplied by the same power line (SE), into direct voltage, available at output terminals of said (AC/DC) rectifier, with each said generator device (DC/AC_{J}), belonging to a corresponding adjustment unit (UR_{J}), being constituted by a (DC/AC) inverter device for transforming the direct voltage, supplied by said (AC/DC) rectifier, into alternating voltage of pre-definable characteristics, supplied to the respective electric transformer (T_{J}).

7. A system, according to claim 1, wherein said power line (SE) supplies an alternating voltage, and each said adjustment unit (UR_{J}) includes also a (AC/DC_{J}) rectifier device, interposed between said power line (SE) and a corresponding said alternating voltage generator device (DC/AC_{J}), for converting alternating voltage supplied by the same power line (SE), into direct voltage, available output terminals of said rectifier device, with each said generator device (DC/AC_{J}), belonging to a corresponding adjustment unit, being constituted by a (DC/AC_{J}) inverter device for transforming the direct voltage, supplied by said (AC/DC_{J}) rectifier, into alternating voltage of pre-definable characteristics, supplied to a respective electric transformer (T_{J}).

8. A system, according to claim 1, wherein at least one part of said electric transformer devices (T₁, T₂, . . . , T_{J}, . . . , T_{N}), belonging to a corresponding adjustment units (UR₁, UR₂, . . . , UR_{J}, . . . , UR_{N}), is constituted by a single electric transformer, provided with: as many primary windings, each primary winding of said many primary windings being connected to output terminals of a respective generator device (DC/AC_{J}); said single electric transformer having only one secondary winding connected in series along said electric circuit (E) for in-series connection of said light sources (SI₁, SI₂, . . . , SI_{J}, . . . , SI_{N}).
